(19) United States
(12) Patent Application Publication
(10) Pub. No.: US 2007/0063588 A1
(43) Pub. Date: Mar. 22, 2007

(54) Method and apparatus for storing and protecting conduit

(76) Inventor: Paul B. Stoeppelwerth, Alpharetta, GA (US)

Correspondence Address: PARKS KNOWLTON - PK001, 1117 PERIMETER CENTER WEST, SUITE E402, ATLANTA, GA, 30338, US

(21) Appl. No.: 10/570,905

(22) PCT Filed: Feb. 28, 2005
(86) PCT No.: PCT/US05/06374

§ 371 Date: Mar. 7, 2006

(30) Foreign Application Priority Data
Mar. 3, 2004 (US) 60/549714

(51) Int. Cl. H02J 3/14

(52) U.S. Cl. 307/38

(57) ABSTRACT

Taught herein is a manifold (10) for housing and outlet (24) and related conduit (19). The manifold (10) provides a means for gathering, storing and protecting excess conduit associated with the outlet and the conduit connected to the outlet (16). The manifold includes conduit apertures (15) to allow conduit to ingress and egress the manifold. The manifold may also include ventilation apertures (18) to allow airflow. The manifold may (10) be a clam-shell style housing, with hingedly attached top and bottom portions (12, 14). Additionally, the manifold may be made of a fire-resistant material and may include a locking device (22) to secure the manifold in a closed condition. The present invention also teaches the method of gathering, storing and protecting an outlet and related excess conduit within a ventilated manifold.

### FIELD OF THE INVENTION

The present invention relates to a conduit manager, and, more particularly, to a receiving manifold with a conduit manager that gathers, stores and protects the conduit while providing a protective cover over the connection points at the manifold, such as the electrical cords, plugs and structure associated with a power supply strip.

### BACKGROUND OF THE INVENTION

Many different environments call for conduit being directed to and collected at a manifold. Conduit such as electrical cords, medical tubing, plumbing, pneumatics and the like are routed to and from the necessary devices, and often converge at junctures and terminals. A common problem of clustering such cords or hoses includes safety hazards and user frustration.

For example, it is all too common that a power supply at a home office is simply a mass of cords plugged into a power strip, including those having two-prong plugs, grounded plugs, transformers and the like. The cords from a computer, printer, lamp, telephone, fax machine, and other appliances or devices may converge at one power strip or surge protector. The mass of cords pose issues of frustration and safety to users, and hazards to the area and the devices.

Various attempts to solve these problems exist in the art. For example there exists a power strip cover, for encasing a power strip, that provides a center slot though which individual cords can exit. The problem sought to be solved there appears to be limited to preventing a small child from accessing electrical plugs and outlets. Another aspect of that apparatus appears to be aligning the egress of the cords with the center slot. However that apparatus does not organize or store the excess conduit.

One attempt to provide a cord manager discloses a method and kit for securing cord connections to an electronic device by setting an electronic device on a flexible pad and securing the connecting cords to the pad. In this manner, the cords are organized and secured. Another attempt to organize and secure cords includes a fabric pack comprising attached pockets with closures, through which outlets or apertures used in running a computer may be placed. However these flexible packs do not provide a supply or surge protector nor do they provide a sturdy device suitable for vigorous use.

Therefore, no known solution teaches one structure for gathering, organizing, and storing a plurality of conduits and a power strip or surge protector in a housing providing a protective cover that allow for vigorous use. Thus, a need exists in the field of conduit management to address these deficiencies and inadequacies.

### SUMMARY OF THE INVENTION

The present invention overcomes the deficiencies and inadequacies of the prior art by providing a manifold to gather, store, and protect conduit. In one exemplary embodiment, the present invention affords the user a manifold or housing, which receives a power strip and includes a means for gathering and storing the related electrical cords. The manifold may be constructed of a fire-resistant material, such as a rigid, molded plastic, for safety.

The means for gathering and storing include a plurality of posts upon which cords may be wrapped and stored. The manifold may also include at least one conduit aperture through which the related electrical cords may ingress and egress the manifold. A bottom portion of the manifold may be separably attached to at least one top portion with a hinge device. The hinge device may be any hinge system, including but not limited to a live hinge, weakened line or the like. The top and bottom portions may be secured with a locking device for additional safety.

Another embodiment of the invention provides at least one ventilation aperture in the manifold to allow airflow. Some electrical devices have transformers that require ventilation so as to not overheat. In addition, the manifold may have feet or bumpers to both allow the manifold to stand on one end and to provide a non-skid bottom surface. The combination of a housing with a non-skid bottom surface may allow the user to set items, such as a garbage can or house plant atop the closed manifold so as to make better use of the floor space.

Other embodiments of the invention teach systems and methods for gathering, storing and protecting conduits. For example, a system and method of storing a power strip—with or without a surge protector—and all related electrical cords includes placing the power strip within a manifold, wrapping all of the electrical cords within the manifold interior, and securing the manifold in a closed condition.

The foregoing has broadly outlined some of the aspects and features of the present inventions, which should be construed to be merely illustrative of various potential applications of the invention. Other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a top view of a manifold interior.

FIG. 2 is a top view of a manifold interior with a power strip or surge protector.

FIG. 3 is a perspective view of a closed manifold.

### DETAILED DESCRIPTION

As required, detailed embodiments of the present invention are disclosed herein. It will be understood that the disclosed embodiments are merely examples to illustrate aspects of the invention that may be embodied in various and alternative forms. The figures are not necessarily to scale, and some features may be exaggerated or minimized to show details of particular components. In other instances, well-known materials or methods have not been described in detail to avoid obscuring the present invention. Therefore, specific structural and functional details disclosed herein are not to be interpreted as limiting, but as a basis for the claims and for teaching one skilled in the art to variously employ the present invention.

Referring now to the drawings in which like numerals indicate like elements throughout the several views, the drawings illustrate various aspects of exemplary embodiments of a conduit-receiving manifold according to the teachings of the present invention.

It is to be understood that the term “conduit” used herein, including in the claims, includes all manner of cords, cables, lines, wires, hoses, filaments, pipes, tubes, ribbons, tape and the like, whether flexible or rigid, associated in any way with supplying or receiving electrical, chemical, pneumatic, hydraulic, and the like subject matter. In addition, the term “manifold” used herein, including in the claims, is used in the broadest sense to include any chamber or device that includes an outlet for connecting to the conduit for supplying or receiving the subject matter. Here the manifold is illustrated as essentially a clam-shell shaped housing. However the exterior shape and appearance is merely a design choice. Here the term “outlet” includes any connector(s) for attaching to conduit associate with electrical, chemical, pneumatic, hydraulic, and the like subject matter. For the purpose of teaching the invention with the following exemplary embodiments, the portion of the manifold that receives an outlet that is power strip or surge protector is labeled as the bottom, and the adjoining portion is labeled the top.

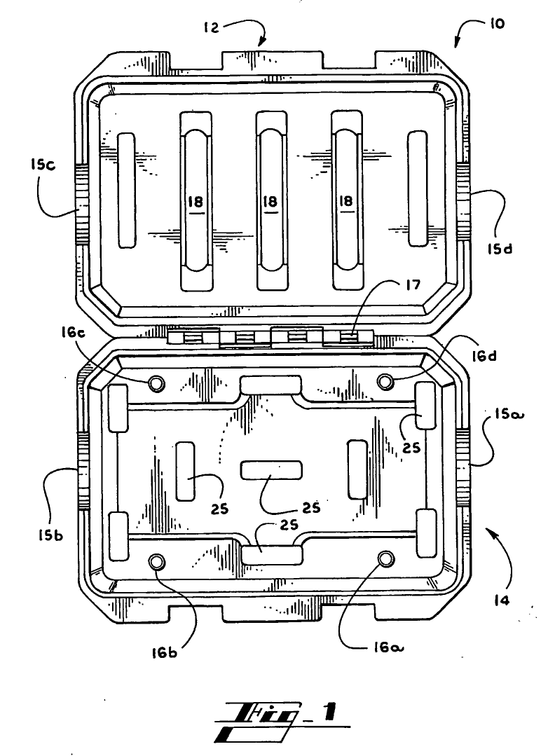

FIG. 1 is a top view of an open manifold 10, showing the interiors of both the top portion 12, or cover, and the bottom portion 14 of the manifold 10. The illustrated portions 12 and 14 may be constructed from any suitable material, including but not limited to plastic, wood, fabric, metal, fire-resistant materials and the like. In this exemplary embodiment, manifold portions 12 and 14 are constructed from a molded plastic.

A hinge device 17 connects the two portions 12 and 14. In this exemplary embodiment, hinge device 17 is a rod or pin that connects the two manifold portions 12 and 14 in a foldable manner. In alternative embodiments, the hinge device 17 may include any hinge system, live hinge, weakened line, fold line or the like. The two portions 12 and 14 close together, in an essentially clam-shell manner, along the hinge device 17. Any reference to hinged connection should not be construed as necessarily referring to a junction including a single hinge only; indeed, it is envisaged that hinged connection can be formed from one or more potentially disparate means for hingedly connecting materials.

A plurality of optional ventilation apertures 18 are shown, which allow air to flow in and out of the manifold 10. Ventilation apertures allow airflow to transfer heat out of the manifold. For example, some items plugged in to a power strip may include a power transformer unit that emits heat. Such units may require ventilation so as to not overheat and fail to function. In this exemplary embodiment, the ventilation apertures may be in the top portion 12 of the manifold. However, in alternative embodiments, a single or multiple ventilation aperture(s) may be in any wall or panel of portions 12, 14.

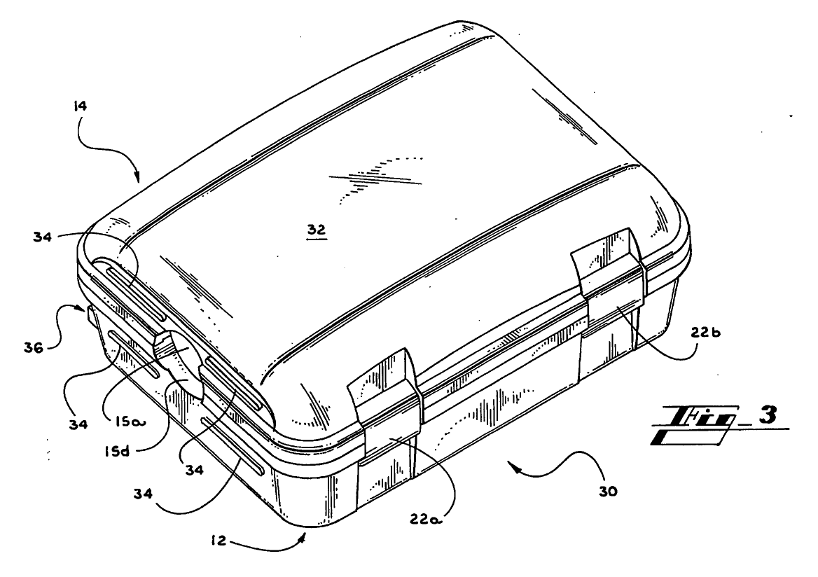

Four cut-outs 15a-15d, as will be shown more clearly with reference to FIG. 3, align to form apertures when manifold 10 is in a closed condition. In this exemplary embodiment, a cut-out may be any notch or removed section of manifold 10. Cut-outs 15a-15d allow conduit to pass in and out of the manifold 10. For example, when manifold 10 is closed along hinge device 17, conduit cut-out 15a aligns with cut-out 15d to leave an aperture through which conduit may exit and enter the manifold 10. In the same manner, cut-out 15c aligns with cut-out 15b. In this exemplary embodiment, both the cords of a power strip power supply and the cords of devices plugged into the power strip may pass through the conduit apertures on either side of the manifold 10.

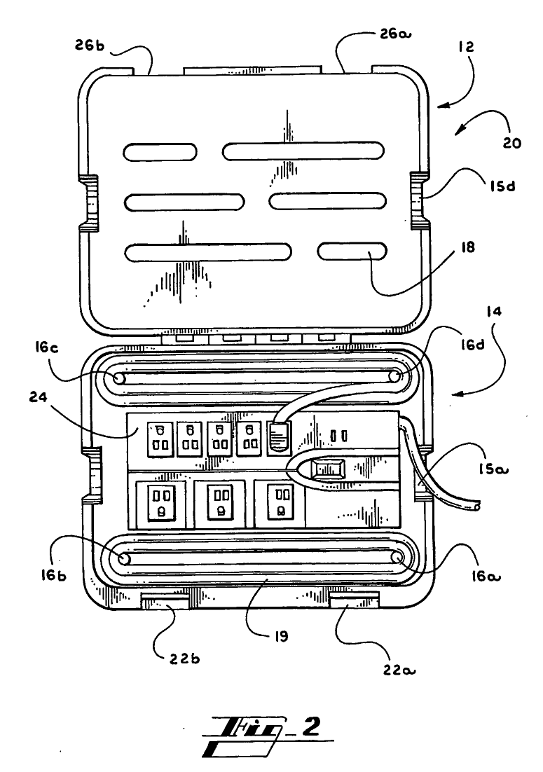

Referring now to FIG. 2, bottom portion 14 receives a power strip 24. The power strip 24 may be any power outlet device, including but not limited to multiple outlet devices, power distribution units, surge protectors and the like. The power strip 24 may be attached or removably attached to bottom portion 14 by a means for attaching 25 (best shown in FIG. 1), including but not limited to concavities, clips, straps, ties, snaps, Velcro®, adhesives, welding, monolithic molding, combinations thereof, and the like.

Referring still to FIG. 2, the present invention also provides a means for gathering and storing conduit so that it is removably attached to the interior of the manifold 20. For example, and not by way of limitation, said means for gathering and storing may include concavities, posts, clips, straps, ties, snaps, Velcro®, parts thereof, combinations thereof, and the like. In the exemplary embodiment of FIG. 2 the bottom portion 14 includes four posts 16a-16d (also shown in FIG. 1), being substantially perpendicular to the plane of the bottom portion 14, upon which conduit may be gathered and stored. Here, multiple power cords 19 may be wrapped around posts 16a and 16b.

Optional means for securing the manifold in a closed condition, such as locking devices 22a and 22b, may be attached to the manifold 20. In this exemplary embodiment, locking devices 22a and 22b are attached to the bottom portion 14 of manifold 20 and may be received by cut-outs 26a and 26b of the top portion 12, respectively. Here locking device 22a is a clip that fits snugly but removably onto the molded shape of cut-out 26a. Locking device(s) 22a and 22b may be any clip, clasp, snap, lock, strap or the like, that will removably attach, or secure, top portion 12 to bottom portion 14.

FIG. 3 is a perspective view of a closed manifold 30. Cut-outs 15a and 15d align to form a conduit aperture. Exterior top panel (not shown) may be a substantially planar surface suitable for placing on the floor or other horizontal surface. Similarly, the exterior bottom panel 32 may be available as a substantially flat surface for the placement of a decorative or a useful article.

FIG. 3 illustrates an embodiment wherein the ventilation apertures 34 are on the sides of manifold 30, allowing manifold 30 to be placed horizontally upon an exterior panel without blocking airflow. This configuration provides a water-resistant manifold. Manifold 30 may also include at least one means for skid-resistance, shown as a bumper or foot 36 in this exemplary embodiment, to allow manifold 30 to stand up on one end. Foot 36 may be any means for skid-resistance, such as any foot or bumper constructed from a suitable material including but not limited to rubber, plastic, wood, metal, and the like. In this exemplary embodiment, foot 36 is constructed of rubber or similar high-friction material.

Various illustrated embodiments of the present invention provide to the user exemplary systems for storing and protecting a power strip within a manifold. The system may include a means for gathering and storing both the cord of the power strip and the cords of the items plugged into the power strip. The user may open the manifold and removably attach a power strip, as described above. The user may run the power cord of the power strip through the conduit apertures of the manifold. The user may plug items into the power strip. The user may utilize the means for gathering and storing the cords within the manifold, as described with reference to FIG. 2. The necessary lengths of all cords may egress from the manifold through conduit apertures. Thus, these exemplary embodiments of the invention provide to the user an effective system for storing and protecting a power strip and all related conduit.

The present invention has been illustrated in relation to embodiments that are intended in all respects to be illustrative rather than restrictive. Those skilled in the art will recognize that the present invention is capable of modifications and variations without departing from the scope of the invention. Further, as used herein, directional references such as “top”, “base”, “bottom”, “end”, “side”, “interior”, “exterior”, “upper”, “middle”, “lower”, “front” and “rear” do not limit the respective panels of the manifold to such orientation, but merely serve to distinguish these structural characteristics from one another.

1-14. (canceled)

15. A portable power outlet protection system, comprising:
a manifold comprising a first portion and a second portion;
means for securing said portions in a closed position;
at least one power outlet positioned within said manifold; and wherein at least a part of said manifold is constructed of fire-resistant material.

16. The system of claim 15, wherein said manifold further comprises means for skid-resistance.

17. The system of claim 15, wherein said manifold further comprises at least one ventilation aperture.

18. The system of claim 15, wherein said manifold further comprises at least one conduit aperture.

19. The system of claim 15, further comprising means for gathering and storing electrical cord within said manifold.

20. The system of claim 15, further comprising means for attaching said outlet to the interior of said manifold.

21. A portable power outlet protection system, comprising:
a manifold comprising a first portion and a second portion;
at least one power outlet located within said manifold;
a child-resistant means for securing said portions in a closed position; and wherein at least a part of said manifold is constructed of fire resistant material.

22. The system of claim 21, wherein said manifold further comprises means for skid-resistance.

23. The system of claim 21, wherein said manifold further comprises at least one ventilation aperture.

24. The system of claim 21, wherein said manifold further comprises at least one conduit aperture.

25. The system of claim 21, further comprising means for gathering and storing electrical cord within said manifold.

26. The system of claim 21, further comprising means for attaching said outlet to an interior surface of said manifold.

27. A method for protecting a portable power strip, comprising the steps of: acquiring a manifold having:
a first portion;
a second portion releasably attached to said first portion wherein said portions define an interior; and
a power strip with surge protection located within said interior; wherein at least a part of said manifold is constructed of fire-resistant material; and plugging at least one electrical cord into said power outlet.

28. The method of claim 27, further comprising the step of providing a child-resistant means for securing said portions in a closed position.

29. A portable power outlet protection system, comprising:
a manifold comprising a first portion and a second portion;
at least one power outlet located within said manifold; and, a child-resistant means for securing said portions in a closed position.

30. The system of claim 29, further comprising means for gathering and storing electrical cord within said manifold.

31. The system of claim 29, wherein said manifold further comprises means for skid-resistance.
